(19) United States
(12) Patent Application Publication
(10) Pub. No.: US 2023/0102500 A1
(43) Pub. Date: Mar. 30, 2023

(54) TECHNIQUE FOR ACTUATING A ROBOTIC APPARATUS

(71) Applicant: TATUM ROBOTICS LLC, Hudson, MA (US)

(72) Inventor: Samantha JOHNSON, Hudson, MA (US)

(73) Assignee: TATUM ROBOTICS LLC, Hudson, MA (US)

(21) Appl. No.: 17/950,862

(22) Filed: Sep. 22, 2022

Related U.S. Application Data
(60) Provisional application No. 63/360,350, filed on Sep. 25, 2021.

(51) Int. Cl. B25J 9/16

(52) U.S. Cl. CPC B25J 9/1635; B25J 9/1697

(57) ABSTRACT

A technique for actuating a robotic apparatus is disclosed. In one particular embodiment, the technique may be realized as an apparatus for providing controlled movement of a robotic appendage, comprising a digit, wherein the digit comprises a first joint and a second joint, and an actuator configured to control a degree of freedom of the digit. The actuator causes the first joint to bend at a first rate from a first position to a second position and the second joint to bend at a second rate from a third position to a fourth position. The first rate is faster than the second rate.

### CROSS-REFERENCE TO RELATED APPLICATIONS

This patent application claims priority to U.S. Provisional Patent Application No. 63/360,350, filed Sep. 25, 2021, which is hereby incorporated by reference herein in its entirety.

### FIELD OF THE DISCLOSURE

The present disclosure relates generally to robotics and, more particularly, to a technique for actuating a robotic apparatus.

### BACKGROUND OF THE DISCLOSURE

Currently, robotics or systems that attempt to mimic the movement of human sign languages, specifically, for example, human tactile sign languages, which require a user to touch the robotic or system to interpret the sign language, are not suitable for safe and convenient customer or personal use. Pneumatic, air-based systems possess the flexibility to mimic the complexity of human sign language, but the compressed air is unsafe in a consumer home. Directly actuated systems enable the precise control of individual finger joints required to accurately sign, but often result in a high grip strength that can injure users. Current systems additionally focus only on the hand rather than the full arm or body, wherein an arm, body, and/or head are required to add meaning to all signs. An apparatus that is capable of accurately and precisely manipulating small parts such as finger-like digits and/or larger parts similar to an elbow-like joint, while being safe for an independent DeafBlind user, is required.

### SUMMARY OF THE DISCLOSURE

A technique for actuating a robotic apparatus is disclosed. In one particular embodiment, the technique may be realized as an apparatus for providing controlled movement of a robotic appendage comprising: a digit, wherein the digit comprises a first joint and a second joint; and an actuator configured to control a degree of freedom of the digit, wherein the actuator causes the first joint to bend at a first rate from a first position to a second position and the second joint to bend at a second rate from a third position to a fourth position, wherein the first rate is faster than the second rate.

In accordance with other aspects of this particular embodiment, the actuator comprises a servo, motor, stepper, or linear actuator. In accordance with further aspects of this particular embodiment, the digit comprises a wire, wherein the actuator is configured to control a degree of freedom of the digit by exerting a force on the wire. In accordance with additional aspects of this particular embodiment, the apparatus further comprises one or more return actuators, wherein the one or more return actuators are configured to return the first joint to the first position and return the second joint to the third position.

In accordance with other aspects of this particular embodiment, the apparatus further comprises an additional actuator configured to control an additional degree of freedom of the digit. In accordance with another embodiment, the additional actuator comprises an actuator configured to control flexion at a third joint of the digit. In accordance with another embodiment, the additional actuator comprises an actuator configured to control adduction and abduction of the digit. In accordance with another embodiment, the additional actuator is located at the point of motion and is configured to directly drive the digit.

In accordance with other aspects of this particular embodiment, the apparatus comprises a body, wherein the body comprises an arm, wherein the arm comprises the digit. In accordance with another embodiment, the body comprises a head. In accordance with another embodiment, the apparatus is configured to change a position of the arm or digit to be in contact with the head. In accordance with other aspects of this particular embodiment, the arm comprises a shoulder joint, an elbow joint, and a wrist joint. In accordance with other aspects of this particular embodiment, the apparatus comprises a user interface. In accordance with other aspects of this particular embodiment, wherein the apparatus comprises a camera. In accordance with another embodiment, the camera is capable of gesture recognition. In accordance with further aspects of this particular embodiment, the apparatus comprises a physical feedback mechanism. In accordance with another embodiment, the physical feedback mechanism comprises a proximity sensor.

In accordance with further aspects of this particular embodiment, the actuator is controlled by a processor. In accordance with another embodiment, the processor is connected to a network.

In another particular embodiment, the technique may be realized as a method for providing controlled movement of a robotic appendage, comprising receiving a command to control a degree of freedom of a digit, wherein the digit comprises a first joint and a second joint, using an actuator to cause the first joint to bend at a first rate from a first position to a second position and the second joint to bend at a second rate from a third position to a fourth position, wherein the first rate is faster than the second rate.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 illustrates a robotic apparatus in accordance with an embodiment of the present disclosure.

FIG. 2 illustrates a two-armed robotic apparatus in accordance with an embodiment of the present disclosure.

FIG. 3 illustrates a one-armed robotic apparatus in accordance with an embodiment of the present disclosure.

FIG. 4 illustrates a user interface of a robotic apparatus in accordance with an embodiment of the present disclosure.

FIG. 5 illustrates a user interface of a robotic apparatus in accordance with an embodiment of the present disclosure.

FIG. 6 illustrates an arm and shoulder of a robotic apparatus in accordance with an embodiment of the present disclosure.

FIG. 7 illustrates an arm of a robotic apparatus in accordance with an embodiment of the present disclosure.

FIG. 8A illustrates a palm and wrist of a robotic apparatus in accordance with an embodiment of the present disclosure.

FIG. 8B illustrates a palm and wrist of a robotic apparatus in accordance with an embodiment of the present disclosure.

FIG. 8C illustrates a side view of a palm and wrist of a robotic apparatus in accordance with an embodiment of the present disclosure.

FIG. 8D illustrates a side view of a palm and wrist of a robotic apparatus in accordance with an embodiment of the present disclosure.

FIG. 9A illustrates a wrist socket of a robotic apparatus in accordance with an embodiment of the present disclosure.

FIG. 9B illustrates a wrist socket of a robotic apparatus in accordance with an embodiment of the present disclosure.

FIG. 10A illustrates a wrist socket of a robotic apparatus in accordance with an embodiment of the present disclosure.

FIG. 10B illustrates a wrist socket of a robotic apparatus in accordance with an embodiment of the present disclosure.

FIG. 11A illustrates a socket of a robotic apparatus in accordance with an embodiment of the present disclosure.

FIG. 11B illustrates a socket of a robotic apparatus in accordance with an embodiment of the present disclosure.

FIG. 12 illustrates multiple views of a digit of a robotic apparatus in accordance with an embodiment of the present disclosure.

FIG. 13A illustrates tendons of a digit of a robotic apparatus in accordance with an embodiment of the present disclosure.

FIG. 13B illustrates a tendon of a digit of a robotic apparatus in accordance with an embodiment of the present disclosure.

FIG. 14A illustrates a digit of a robotic apparatus in accordance with an embodiment of the present disclosure.

FIG. 14B illustrates a digit of a robotic apparatus in accordance with an embodiment of the present disclosure.

FIG. 15A illustrates a digit of a robotic apparatus in accordance with an embodiment of the present disclosure.

FIG. 15B illustrates a digit of a robotic apparatus in accordance with an embodiment of the present disclosure.

FIG. 16 illustrates an actuated digit of a robotic apparatus in accordance with an embodiment of the present disclosure.

FIG. 17A illustrates a thumb digit of a robotic apparatus in accordance with an embodiment of the present disclosure.

FIG. 17B illustrates a thumb digit of a robotic apparatus in accordance with an embodiment of the present disclosure.

FIG. 18 is a flow diagram depicting an embodiment of a process for a robotic apparatus.

FIG. 19 is a flow diagram depicting an embodiment of a process for a processor in communication with the robotic apparatus.

FIG. 20 is a flow diagram depicting an embodiment of a process for a processor in the robotic apparatus.

### DETAILED DESCRIPTION OF EMBODIMENTS

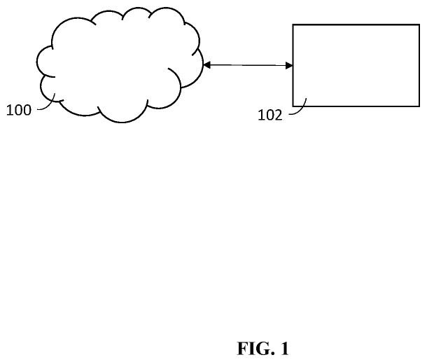

Referring to FIG. 1, there is shown a robotic apparatus in accordance with an embodiment of the present disclosure. Robotic apparatus 102 is in communication with network 100. Network 100 may comprise a cloud, a processor, and/or data storage. In some embodiments, network 100 provides commands to robotic apparatus 102. For example, network 100 provides instructions to one or more actuators in robotic apparatus 102, which causes parts of the apparatus such as digits, hands, or arms, to move. Network 100 may provide detailed instructions to the one or more actuators, such as a rate at which the actuators move the parts of the apparatus, or an order of actuation for different actuators. In some embodiments, the backend of the actuators sit in network 100. Network 100 may store a library of sign languages' signs and the corresponding actuator commands required for each sign. In some embodiments, robotic apparatus 102 is capable of machine learning. Robotic apparatus 102 may be configured to alter the stored library of sign language signs stored in network 100 based on interactions, for example based on feedback received by human users interacting with robotic apparatus 102. For example, apparatus 102 may revise a stored instruction to move an actuator at a slower rate for a specific sign if a threshold of users provide feedback to apparatus 102 that they do not understand the sign at a faster rate.

In various embodiments, network 100 comprises one or more edge servers, management servers, processing servers, or resource servers. Edge servers are accessible from the internet and communicate requests to internal management servers. Management servers manage tasks. Processing servers perform tasks requested by management servers and perform background tasks. Resource servers may be specific to various external services such as an eBook, email, or social media site.

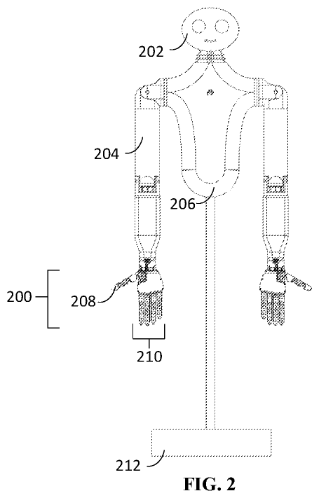

FIG. 2 illustrates a two-armed robotic apparatus in accordance with an embodiment of the present disclosure. As shown, the apparatus comprises head 202, arm 204, hand 200, body 206, and base 212. The apparatus comprises a body, wherein the body comprises an arm, wherein the arm comprises one or more digits. In some embodiments, arm 204 comprises a shoulder joint, an elbow joint, and a wrist joint. Hand 200 as shown comprises thumb 208 and fingers 210. As shown, four fingers and one thumb are present.

Head 202 is attached to body 206 as shown. Head 202 may be designed to look and/or feel similar to a human head. For example, head 202 may include a nose and/or ear appendages or may comprise soft materials. In some embodiments, the robotic apparatus is capable of moving various appendages, such as a finger, hand, or arm, in relation to its body and head. For example, the apparatus may be configured to change a position of the arm or digit to be in contact with the head. Therefore, the apparatus is capable of signing signs that require gestures involving the body or head.

The apparatus may be comprised of user-tailored materials that are durable and ergonomic. For example, the apparatus may comprise hypoallergenic, moisture resistant, and non-degradable materials. Electrical components may be encased such that electronics, cables, or wires are not exposed. Flexible components such as arm 204 and hand 200 may comprise flexible exteriors to ensure compliance and safety. A non-limiting list of flexible materials used comprise thermoplastic polyurethane (TPU) or thermoplastic elastomers (TPE), polyurethane rubber, silicone, flexible and elastic polyjets, and flexible and elastic resins. Structural components such as the internal arm, wrist, and palm structures may utilize stiffer materials such as nylon-based materials, carbon fiber-filled materials, acrylonitrile butadiene styrene (ABS), polyamide (PA), polycarbonate (PC), polylactic acid (PLA), machined metals, or polyethylene terephthalate (PET)-based materials. In some embodiments, a glove is placed over hand 200. The glove may comprise flexible materials such as silicon, textiles, or rubber.

In some embodiments, movement in the arm, hand, fingers, and thumb of the apparatus is controlled by one or more actuators. In some embodiments, the one or more actuators are stored in body 206, arm 204, or a location within the apparatus that has space. In some embodiments, actuators are stored external to hand 200 in order to allow for dexterous hand movement and use of larger actuators, which are lower in cost than miniature actuators. In other embodiments, miniature actuators are utilized in hand 200 or elsewhere within the apparatus. In various embodiments, the one or more actuators comprise various mechanisms, such as a servo, motor, stepper, or linear actuator. The one or more actuators may be electrically and physically connected to a microcontroller or processor to provide instructions to the one or more actuators. In various embodiments, multiple actuators are connected a same microcontroller or processor, each actuator is connected to a different microcontroller or processor, or there is a combination of the two. In some embodiments, one, multiple, or all actuators used within the robotic apparatus are configured to enable speed control, such that the speed of the actuators can be set. For example, a microcontroller or processor connected to an actuator may be used to control the actuator's speed to ensure safety.

Base 212 may comprise wheels or other methods to easily transport the robotic apparatus conveniently. Base 212 may be weighted to provide stability to the apparatus.

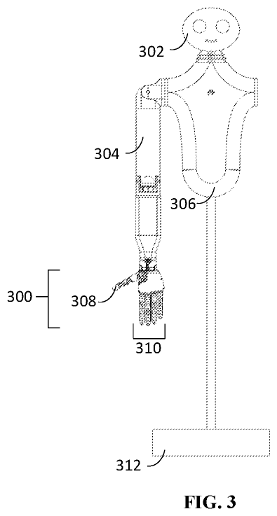

FIG. 3 illustrates a one-armed robotic apparatus in accordance with an embodiment of the present disclosure. As shown, the apparatus comprises head 302, arm 304, hand 300, body 306, and base 312. Hand 300 as shown comprises thumb 308 and fingers 310. In various embodiments, various configurations of numbers of appendages are used. For example, the robotic apparatus may be configured to have a number of digits, hands, or arms atypical to the normal human if desired.

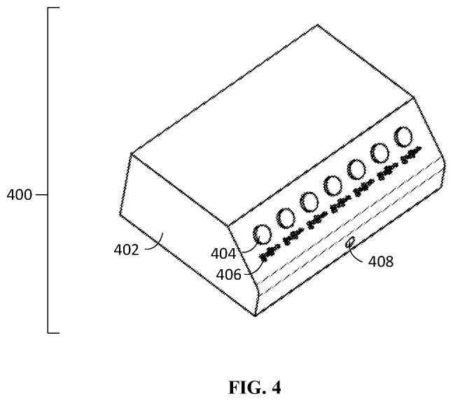

FIG. 4 illustrates a user interface of a robotic apparatus in accordance with an embodiment of the present disclosure. In some embodiments, the apparatus comprises a user interface. The user interface may comprise methods of receiving instruction such as buttons, a touch screen, braille markings or raised writing, and/or a camera for user interaction. Upon receiving instruction, the instructions may be sent to network 100 of FIG. 1. The robotic apparatus may then be triggered to address the user's instruction. For example, a user may utilize the robotic apparatus to sign the user's email, sign a chosen book, or sign messages received. A user may utilize the robotic apparatus to perform non-signing actions, such as deleting an email, message, or book. In various embodiments, the robotic apparatus is able to output tactile sign from an input of direct text, direct voice input, text-based communication mediums such as emails and eBooks, and/or remote, real-time signing with other users. For example, a user of a first robotic apparatus can sign to her apparatus, and a second user can receive the message via his respective second robotic apparatus.

In some embodiments, the robotic apparatus is configured to output tactile sign language to a user, such that the user can use his or her one or more hands to touch and feel the signs that are output by the robotic apparatus. For example, a user may hold on to a hand component of the robotic apparatus while the robotic apparatus moves its hand component to form different signs. In some embodiments, the robotic apparatus is configured to communicate tactile sign languages precisely, safely, and/or ergonomically, such that the robotic apparatus mimics a human signers' feel and movement. In some embodiments, the robotic apparatus is configured to communicate feedback to the user. For example, if a user is holding too tightly on the robotic apparatus or putting too much weight on the robotic apparatus, the robotic apparatus may provide feedback to tell the user to use a lighter touch. The robotic apparatus may provide feedback when the user is preventing the robotic apparatus from movement without risk of damage to the robotic apparatus and/or user. In some embodiments, the robotic apparatus utilizes one or more proximity sensors, such as a pressure sensor, current monitoring, or various other mechanisms to determine the pressure its component is under. In some embodiments, the robotic apparatus provides feedback via a physical output, such as a vibration.

The buttons may be different shapes, textures, and/or colors. User interface 400 as shown comprises mount 402, which comprises buttons 404, braille markings 406, and camera 408. While buttons 404 are linear as shown, in a different embodiment, the buttons may be in the format of a number pad. While braille markings 406 are shown below buttons 404, braille markings may be included on the buttons themselves. User interface 400 may comprise a full braille keyboard.

In some embodiments, camera 408 is configured for two-way communication and gesture recognition functionalities. For example, camera 408 can capture a user's sign language signs such that a user can communicate with the robotic apparatus. One or more cameras may be incorporated in the robotic apparatus, for example, on the base, body, or head of the robotic apparatus.

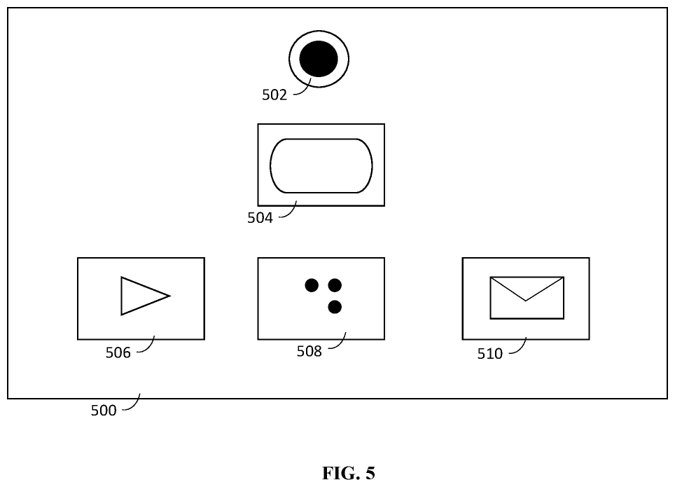

FIG. 5 illustrates a user interface of a robotic apparatus in accordance with an embodiment of the present disclosure. User interface 500 shows a different configuration from user interface 400. User interface 500 may be mounted as a panel on a body of the robotic apparatus. As shown, user interface 500 comprises camera 502, play button 506, braille-marked button 508, and email icon 510. In some embodiments, a user can play, pause, and stop media or signing from the apparatus using the user interface. In some embodiments, the robotic apparatus comprises a physical feedback mechanism. For example, the physical feedback mechanism may comprise a proximity sensor. In various embodiments, the proximity sensor comprises a pressure sensor or a light sensor. The proximity sensor may be covered in a soft material or a pad for safe and ergonomic use. User interface 500 comprises backchanneling mechanism 504. Backchanneling mechanism 504 comprises a mechanism to provide feedback to the robotic apparatus from a user. For example, backchanneling mechanism 504 may be used to provide feedback that a user is understanding the content that the robotic apparatus is signing or may be used to allow for active listening of the user. Backchanneling mechanism 504 may comprise a proximity sensor, such as a pressure sensor that a user can press. In various embodiments, backchanneling mechanism 504 is located on a hand, arm, user interface, or other location on the robotic apparatus. The apparatus may be configured such that physical feedback via the user interface, such as via backchanneling mechanism 504, indicates that the user is understanding the signing provided by the apparatus. In some embodiments, if physical feedback is not received at given intervals, the apparatus will pause the current media or signing. In some embodiments, following the pause, the machine will provide a request to the user to indicate they understand. For example, the apparatus may sign “do you understand?” in a sign language.

In some embodiments, the physical feedback mechanism is positioned on the hand of the robotic apparatus. For example, the physical feedback mechanism comprises a proximity sensor, for example, a pressure sensor that is positioned under a glove or soft covering on the hand. In some embodiments, a light sensor is used as a feedback mechanism.

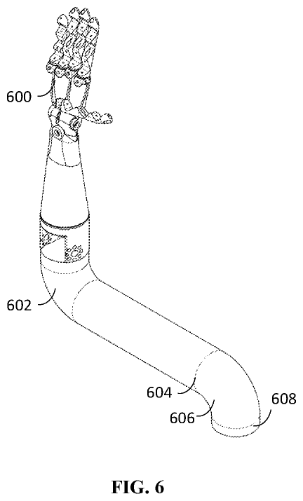

FIG. 6 illustrates an arm and shoulder of a robotic apparatus in accordance with an embodiment of the present disclosure. As shown, hand 600 is connected to an arm. The arm comprises an elbow joint 602, which allows for one degree of freedom in the arm. In some embodiments, elbow joint 602 is driven by an actuator, either directly or through a “tendon-based” configuration, as explained in detail below.

In some embodiments, the shoulder of the arm is driven by three actuators that allow for three degrees of freedom. One, two, or three or more degrees of freedom may be implemented by using the corresponding number of actuators in the shoulder and other parts of the robotic apparatus. As shown, shoulder portion 604 allows for rotation of the shoulder. Shoulder portion 606 enables shoulder flexion and extension. Shoulder portion 608 allows for shoulder abduction and adduction.

The actuators in the arm, as well as the actuators that control movement in the hand, fingers, thumb, or elsewhere of the apparatus are “tendon-based” in some embodiments. That is, the design is similar to the tendons in a human body, but wires are used. For example, a digit comprises a wire, wherein the actuator controls a degree of freedom of the digit by exerting a force on the wire. When the actuator pulls on the wire, the digit bends. In some embodiments, the digit or other apparatus part comprises a mechanism to return the digit or apparatus part back to its original position. In some embodiments, the digit or other body part comprises one or more additional actuators (one or more “return actuators”), which cause the digit or other apparatus part to return to its original position. For example, a first actuator is used to bend the digit or body part, wherein a second actuator is used to straighten the digit or body part. The mechanism to return the apparatus part back to its original position may comprise an active actuator (e.g. applying direct force) or a passive actuator (e.g., a torsion or extension spring or other mechanism that does not require a power source). Actuating an apparatus part in both directions enables the part to return to a baseline position after the part changes position, either actively upon command by the apparatus, or if a user manipulates the part physically.

The one or more actuators in the robotic apparatus arm, as well as the actuators that control movement in the hand, fingers, thumb, or elsewhere of the apparatus are directly driven in some embodiments. That is, a “tendon-like” wire is not used. The actuator is located at the point of motion and moves the apparatus part directly without use of a wire. While example configurations are shown and described regarding numbers of actuators and whether they are tendon-based/directly driven in the physical signing apparatus, a person of ordinary skill in the art would find it obvious that any number of actuators can be used within the physical signing apparatus, and each actuator can either be tendon-based or directly driven.

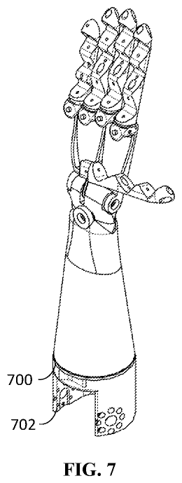

FIG. 7 illustrates an arm of a robotic apparatus in accordance with an embodiment of the present disclosure. FIG. 7 shows wrist rotation part 700 and arm attachment part 702. Wrist rotation part 700 enables the wrist to rotate around the vertical axis of the forearm as shown. Arm attachment part 702 as shown comprises holes to allow for attachment to the upper arm of the robotic apparatus.

In some embodiments, a proximity sensor or physical feedback mechanism is placed on the back of the hand, the palm of the hand, or on the forearm.

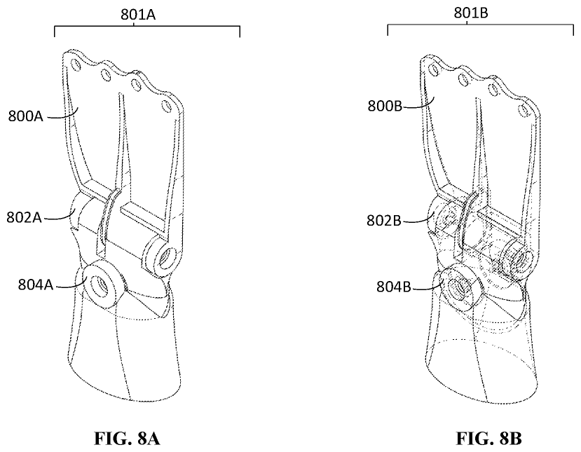

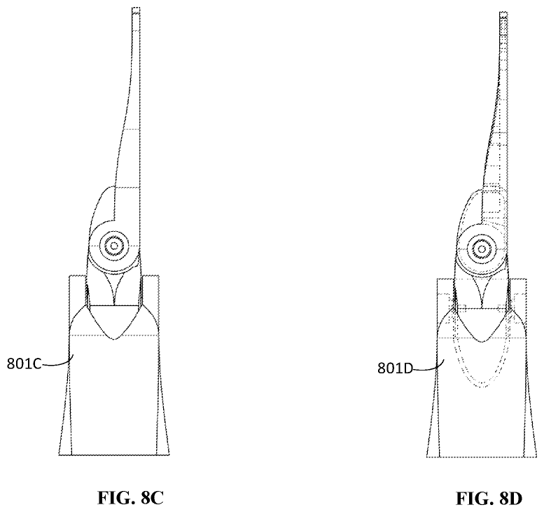

FIG. 8A illustrates a palm and wrist of a robotic apparatus in accordance with an embodiment of the present disclosure. While the example shown and described is for a palm and wrist, an ordinary person of skill in the art would understand that the described example could be utilized to emulate a different body part of a human, for example a human ankle and foot. Hand area 801A comprises palm 800A, wrist flexion/extension part 802A, and wrist abduction/adduction part 804A. In some embodiments, abduction and adduction are enabled by using a saddle-like joint for part 804A.

In some embodiments, the wrist has three degrees of freedom. The first is rotation, as shown in FIG. 7. Rotation may be enabled by direct actuation. The second degree of freedom is flexion (bending the wrist down) and extension (bending the wrist up). In some embodiments, flexion and extension are achieved by using two tendons or wires and one actuator, wherein the actuator is configured to pull either of the two wires, wherein pulling one wire bends the wrist down, and pulling the second wire bends the wrist up. A single wire may also be used wherein the actuator pulls the wire in either a first or second direction to achieve both flexion and extension. Finally, two separate actuators and two separate wires may be used. A person of ordinary skill in the art would find it obvious to use any combination of numbers of wires, actuators, or direct or passive actuation to actuate the wrist and other apparatus parts.

The third degree of freedom is abduction and adduction, for example the waving motion of the hand. Similarly, any combination of using two tendon wires and one actuator, one wire and one actuator, or two wires and two actuators can be utilized to move the hand to the left and right in a waving motion.

FIG. 8B illustrates a palm and wrist of a robotic apparatus in accordance with an embodiment of the present disclosure. Hand area 801B comprises palm 800B, wrist flexion/extension part 802B, and wrist abduction/adduction part 804B. FIG. 8B shows addition detail regarding FIG. 8A.

FIG. 8C illustrates a side view of a palm and wrist of a robotic apparatus in accordance with an embodiment of the present disclosure. Hand area 801C shows a side view of hand area 801A.

FIG. 8D illustrates a side view of a palm and wrist of a robotic apparatus in accordance with an embodiment of the present disclosure. Hand area 801D shows a side view of hand area 801B.

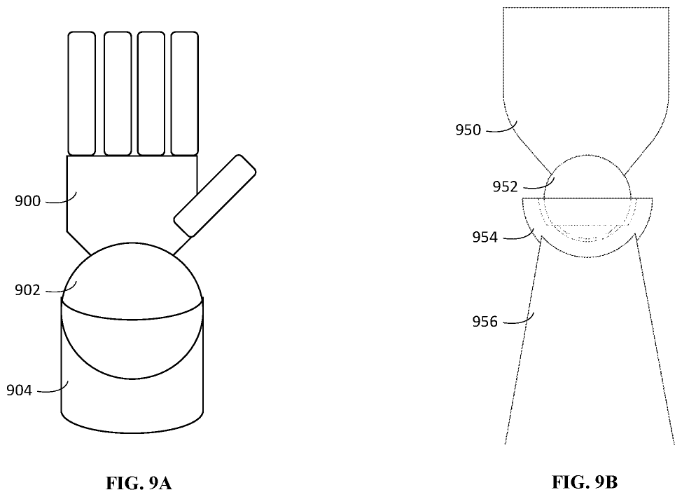

FIG. 9A illustrates a wrist socket of a robotic apparatus in accordance with an embodiment of the present disclosure. In the example shown, hand 900 is attached to saddle joint 904 via ball joint 902. As shown, saddle joint 904 is formed similarly to a human wrist, and ball joint 902 facilitates movement of the wrist. In various embodiments, hand 900 is designed to be the size of various human hands, such as the size of a woman's, man's, or child's hand, depending on the use case. In some embodiments, the hand length is between 4.5 and 8.5 inches and the hand breadth is between 2 and 4.5 inches to mimic a woman's hand.

The fingers of the hand may be able to overcome resistance of a user's hand pressing down on the fingers due to passive and/or active extensions that actuate the fingers in both directions. For example, in the use case of a passive spring actuation, after a user presses the fingers of the apparatus down, they will spring back to their midline.

The palm of the hand may comprise attachment points for the fingers. In some embodiments, the palm comprises saddle joints for each digit in order to facilitate movement of the digits.

FIG. 9B illustrates a wrist socket of a robotic apparatus in accordance with an embodiment of the present disclosure. In the example shown, hand 950 is attached to wrist 956 via ball joint 952 and saddle joint 954. The wrist joint has different designs in various embodiments. For example, as shown, saddle joint 954 is a half sphere-shaped saddle, whereas the saddle joint of wrist 904 is a cylinder.

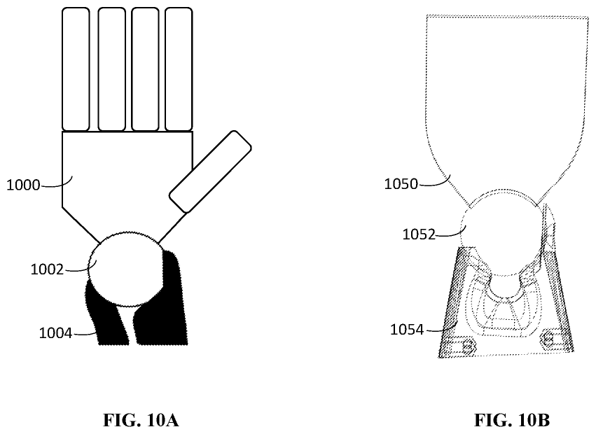

FIG. 10A illustrates a wrist socket of a robotic apparatus in accordance with an embodiment of the present disclosure. FIG. 10A shows another example of a design for the wrist joint. In the example shown, hand 1000 is attached to ball joint 1002 and saddle joint 1004, wherein the saddle joint touches the ball joint at two points. The ball joint does not rest flush against the saddle joint. Therefore, saddle joint 1004 prevents hand 1000 from having a full range of motion. For example, hand 1000 cannot bend from the left and right in FIGS. 10A and 10B as shown because of the walls of saddle joint 1004 prevent the hand 1000 from doing so. As shown, this resembles the anatomy of the human wrist regarding the range of movement enabled by the condyloid synovial joint, which allows a wrist to bend forward and backwards at a greater angle than side to side (abduction/adduction).

In various embodiments, the design of joints varies in order to mimic a human's natural range of movement for the corresponding joint on the human body. For example, a saddle joint may comprise ridges, walls, or cavities in order to limit or allow ranges of motion at various angles and positions for a given joint. A ridge or wall may be used to prevent motion in a certain direction, whereas a cavity may be used to enable further motion in a certain direction. Various designs of saddle joints, including ridges, walls, or cavities, may be used to prevent user confusion (e.g. not allowing the robotic apparatus to move in a way that a human body would not be able to). The design decisions, such as the placement of ridges, walls, or cavities, may also be used to prevent areas of weakness within the robotic apparatus. For example, a thick ridge may be used in a saddle joint to prevent a user from applying too much force on the joint at that position, which would cause the apparatus to break at that point.

FIG. 10B illustrates a wrist socket of a robotic apparatus in accordance with an embodiment of the present disclosure. FIG. 10B shows a more detailed view of FIG. 10A. In the example shown, hand 1050 is attached to ball 1052 and socket 1054, wherein the socket touches the ball at two points.

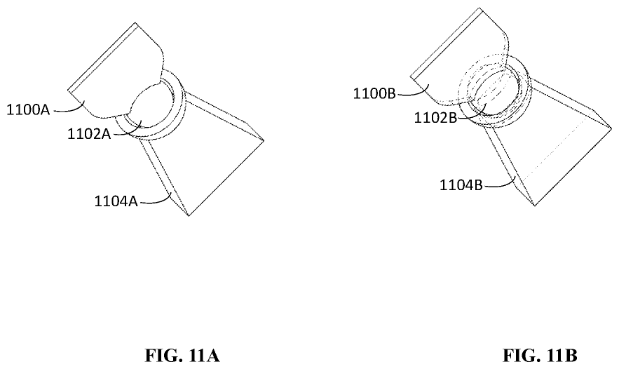

FIG. 11A illustrates a socket of a robotic apparatus in accordance with an embodiment of the present disclosure. In the example shown, first body part 1100A is connected to second body part 1104A via joint 1102A. This joint can be used for the wrist or elsewhere, for example, the elbow.

FIG. 11B illustrates a socket of a robotic apparatus in accordance with an embodiment of the present disclosure. FIG. 11B shows a more detailed view of FIG. 11A. In the example shown, first body part 1100B is connected to second body part 1104B via joint 1102B.

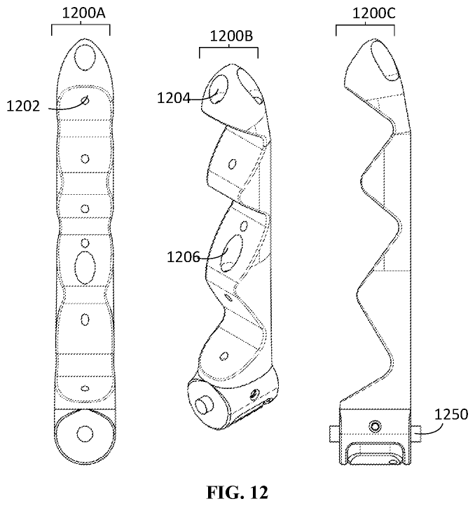

FIG. 12 illustrates multiple views of a digit of a robotic apparatus in accordance with an embodiment of the present disclosure. 1200A shows the underside of a digit, whereas 1200B and 1200C show side views of the same digit. 1200A shows an embodiment of a finger used in the robotic apparatus. Finger 100A shows small holes 1202 throughout the digit, whereas 1200B provides a side view of large holes 1204 and 1206 throughout the digit. In some embodiments, wires are threaded through holes in the digit, wherein the wires are used to actuate movement of the digit. These holes may create channels for the wires, wherein the channels are placed in positions to mimic tendon placement in the human hand. The channels may be placed in positions wherein the wires can actuate apparatus parts in a human-like manner.

Saddle 1250 is used to support abduction. The saddle can be a separate component attached to the finger or can be designed as a part of the finger. In some embodiments, saddle 1250 comprises two components that stick out from a main robotic apparatus part, such as a digit. In some embodiments, wires (“tendons”) are attached to a saddle such as saddle 1250, for example by routing a wire through saddle 1250. The saddle and wires are then used to control a degree of freedom of the main robotic apparatus part. This configuration avoids using a wire (“tendon”) that travels through the length of the finger to control the degree of freedom. In other embodiments, wires are mounted within the finger through channels to control a degree of freedom.

In some embodiments, bearings are added to a saddle used in a joint in the robotic apparatus, for example saddle 1250 in a finger, or a different saddle elsewhere in the robotic apparatus. Bearings may be used to precisely control movement of the robotic apparatus component, such as a finger, for example by controlling friction, speed, or the radius of rotation. For example, the radius of rotation is affected by the size of the bearing. In some embodiments, mechanisms other than a saddle are used in the robotic apparatus, such as a rod or shoulder bolt. For example, a rod can be placed through a robotic apparatus digit or finger, wherein wires are attached to either side of the rod where the ends protrude from the digit or finger. One or more shoulder bolts can similarly be screwed on to the digit, finger, or other robotic apparatus component.

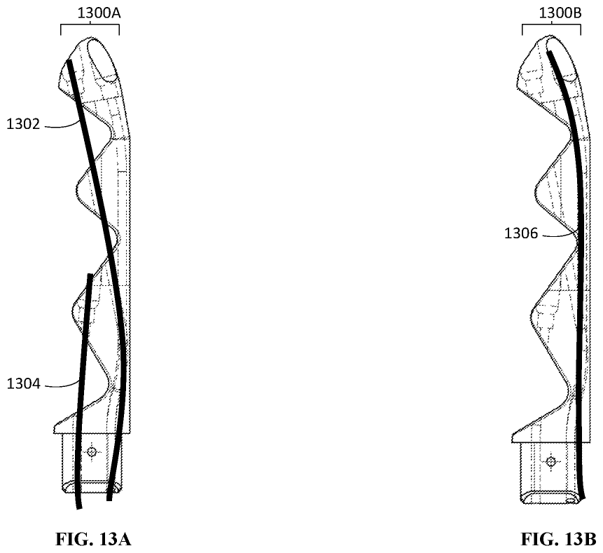

FIG. 13A illustrates tendons of a digit of a robotic apparatus in accordance with an embodiment of the present disclosure. In some embodiments, each digit has four degrees of freedom. For example, a digit may have the following degrees of freedom: (1) flexion at the metacarpal phalangeal joint, which is a patting motion of the finger, (2) adduction/abduction, which is moving the finger left and right, and (3) proximal and distal interphalangeal joint flexion, which is bending a first and second joint within a single finger forward, which provides two degrees of freedom. For flexibility, the degrees of freedom may be implemented using tendon-like wires for actuation in a first direction and springs or other passive mechanisms for actuation in a second direction, reverse to the first direction.

Tendon 1302 and tendon 1304 are positioned within digit 1300A. Tendon 1302 shows an example of a distal and proximal interphalangeal (DIP/PIP) joint flexion tendon. The apparatus digit may be designed to have two joints within a digit, similar to the DIP and PIP joints in a human finger. The joints may be configured to be in a position within the digit such that they mimic anthropomorphic measurements in a human finger, for example based on the distances between the joints and the angles of the joints in a human finger. In some embodiments, the proximal and distal joints (e.g. the joint in the middle of the finger, closer to the palm, and top joint in the finger, closer to the tip of the finger in the apparatus digit are coupled. That is, the joints are not independently actuated, but actuation of one of the joints causes both to move. This coupling may increase the human likeness in movement of the digit. In some embodiments, the middle joint will fully bend first and then the top joint will move slower. This may be achieved by configuring the middle joint to be thinner than the top joint, so that the middle joint will bend first. Configuring one joint to fully bend at a different rate than a second rate can also be achieved by using different materials. For example, the distal joint may comprise a flexible or easier to bend material in comparison to the proximal joint, allowing the distal joint to bend at a faster rate than the proximal joint. In some embodiments, the joint at the very base of the finger, connecting to the palm, is thickest and does not bend when the middle and top joints are actuated. The DIP/PIP (top/middle) joints may be controlled via an actuator and tendons. FIG. 13A shows an embodiment comprising a digit that comprises a first joint and a second joint, an actuator configured to control a degree of freedom of the digit, wherein the actuator causes the first joint to bend at a first rate from a first position to a second position and the second joint to bend at a second rate from a third position to a fourth position, and wherein the first rate is faster than the second rate. The PIP/DIP joints, like other apparatus parts, may be actuated by any combination of powered actuators, tendons, and passive actuation. For example, a single wire may be used wherein a single actuator exerts a force to pull the wire, causing the joints to bend. A spring may be used to return the joints to their original position. Two separate wires may be used to bend and unbend the joints, wherein a single actuator pulls either of the two wires. A single wire may be used wherein a single actuator pulls the wire in either a first direction or a second, reversed direction. Two actuators may be used to pull a single or two wires in either direction.

In some embodiments, the DIP joint (top joint) is removed, and only a PIP joint (middle joint) exists. In some embodiments, the DIP and PIP joints are independently actuated.

In some embodiments, two or more actuators are configured to control two or more degrees of freedom of the digit. For example, tendon 1304 shows an example of a tendon used to control flexion at the base joint of the finger, or the metacarpal phalangeal joint in a human finger equivalent. This enables the motion of patting up and down with a finger. Tendon 1304 may be actuated, directly or passively in both directions, using various numbers of wires or actuators.

FIG. 13B illustrates a tendon of a digit of a robotic apparatus in accordance with an embodiment of the present disclosure. Tendon 1306 is an example of a tendon used to support adduction and abduction of the digit, which is waving the finger left and right. Tendon 1306 can also be used to support extension. In some embodiments, two tendons/wires are used in the apparatus, wherein one is used for adduction and one is used for abduction, but both are controlled by a same actuator. However, any combination of wires and actuators would be obvious to a person of ordinary skill in the art.

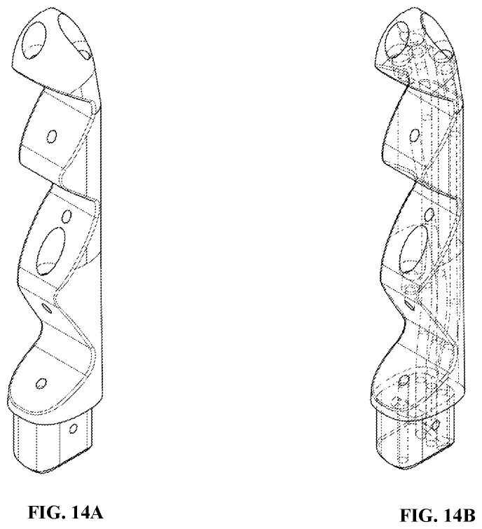

FIG. 14A illustrates a digit of a robotic apparatus in accordance with an embodiment of the present disclosure. FIG. 14A shows another view of a digit. In the example shown, the spaces between joints are open. However, the spaces could also be enclosed. The enclosed space can either be left hollow or can be filled with a highly compressible fill material or support.

FIG. 14B illustrates a digit of a robotic apparatus in accordance with an embodiment of the present disclosure. FIG. 14B shows a detailed view of FIG. 14A.

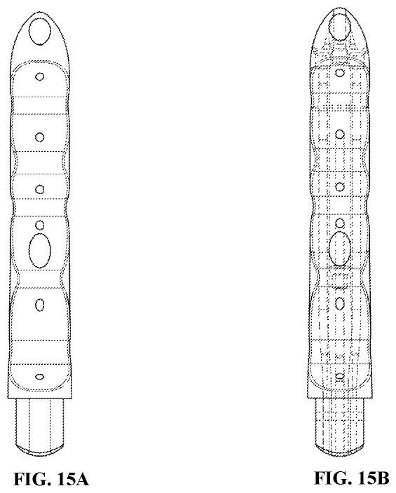

FIG. 15A illustrates a digit of a robotic apparatus in accordance with an embodiment of the present disclosure. FIG. 15A shows another view of a digit.

FIG. 15B illustrates a digit of a robotic apparatus in accordance with an embodiment of the present disclosure. FIG. 15B shows a detailed view of FIG. 15A.

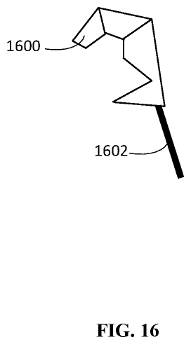

FIG. 16 illustrates an actuated digit of a robotic apparatus in accordance with an embodiment of the present disclosure. FIG. 16A shows digit 1600, which is bent at the DIP/PIP joints. Both the DIP and PIP joints of the digit are actuated. Tendon 1602 is shown protruding from the digit. Tendon 1602 may be attached to an actuator, not shown.

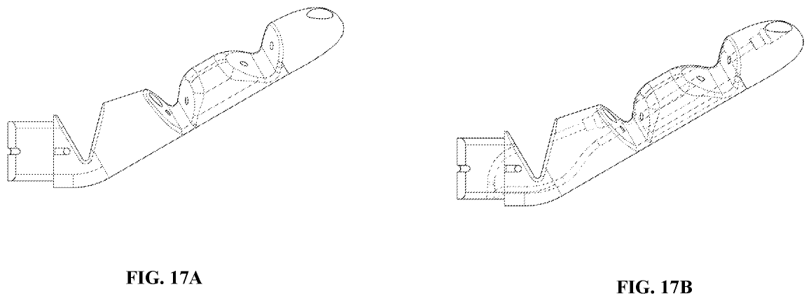

FIG. 17A illustrates a thumb digit of a robotic apparatus in accordance with an embodiment of the present disclosure. In some embodiments, the thumb digit is a different length than the other digits. For example, four long digits and one shorter digit may be used to mimic a human hand. The apparatus may be configured to control three degrees of freedom of the thumb. For example, one degree of freedom is palmer abduction and adduction, which is a sweeping across the palm movement. A second degree of freedom is radial abduction/adduction or opposition, which is the ability to turn and rotate the thumb so that it can touch each fingertip of the same hand. A third degree of freedom is interphalangeal flexion or extension, which allows the thumb to bend in and out. In some embodiments, the apparatus is configured to control fewer or more than three degrees of freedom of the thumb.

In some embodiments, the thumb has three actuators, which are all tendon actuated, to control the described three degrees of freedom of the thumb. Various combinations of direct or tendon-based actuation may be used. For example, in another embodiment, the thumb's radial abduction and adduction is directly driven by an actuator located at the point of motion. Direct actuation may be more precise than tendon-based actuation. For example, providing an instruction to the radial abduction and adduction actuator to move 45 degrees can causes the thumb to move exactly 45 degrees. However, direct actuation results in less fluid movement. Direct actuation may be used for parts of the apparatus wherein the analogous human body part moves in a less fluid manner, such as wrist rotation and thumb radial abduction/adduction. Thereby, accuracy is achieved without sacrificing human-like accuracy.

In the apparatus, the thumb digit may have joints mimicking the proximal and distal phalanx of the human thumb, i.e. the joint at the base of the thumb and in the middle of the thumb. These joints may be placed at an angle with respect to each other rather than being positioned in a straight line, in order to mimic the human body and allow for more biometric movements.

FIG. 17B illustrates a thumb digit of a robotic apparatus in accordance with an embodiment of the present disclosure. FIG. 17B provides a detailed view of FIG. 17A.

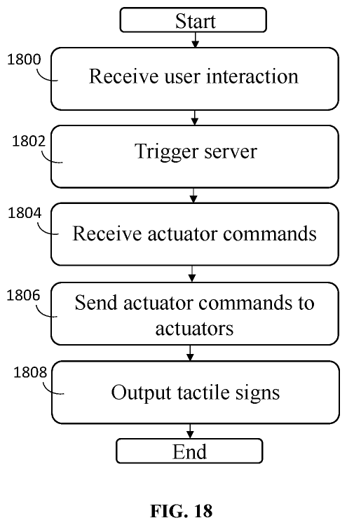

FIG. 18 is a flow diagram depicting an embodiment of a process for a robotic apparatus. At 1800, user interaction is received. User interaction may be received via a user interface of the apparatus or via a physical feedback mechanism. For example, a command may be received from a user interface for the apparatus to sign an eBook to the user. At 1802, a server is triggered. For example, the apparatus's processor may communicate with a network or a cloud, such as network 100 of FIG. 1, and communicate the instructions from the user via a network to a separate processor or server. At 1804, actuator commands are received. For example, actuator commands are received from the cloud. For example, the actuator commands corresponding to physical signs that sign the language of an eBook are received. These instructions may be received based on libraries stored on the cloud. At 1806, actuator commands are sent to actuators. For example, a processor within the apparatus communicates with the one or more microcontrollers of the actuators. At 1808, tactile signals are outputted. The apparatus outputs signs that a user can touch in order to feel and interpret the signs. For example, the microcontrollers cause the actuators to exert force either directly on apparatus parts or on wires, causing apparatus parts to move. The apparatus parts may move in a manner that causes the apparatus to sign a human sign language to the user.

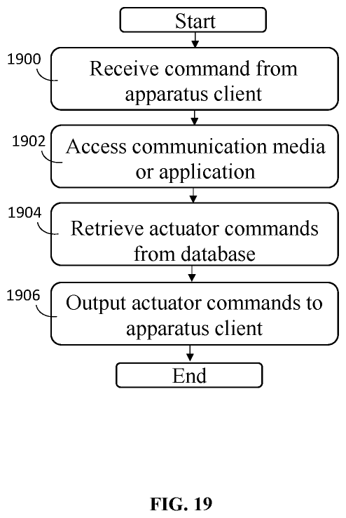

FIG. 19 is a flow diagram depicting an embodiment of a process for a processor in communication with the robotic apparatus. For example, FIG. 19 shows the flow for a processor in the cloud. At 1900, a command from the apparatus client is received. At 1902, a communication media or application is accessed. The processor accesses the email, the eBook, or other media. At 1904, actuator commands are retrieved from a database. At 1906, actuator commands are outputted to the apparatus client.

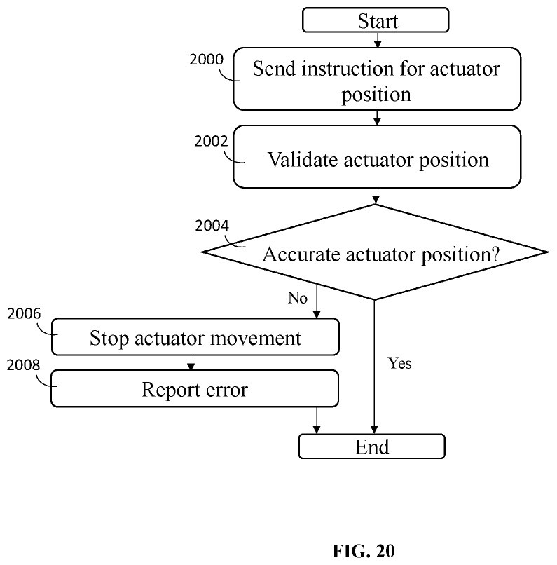

FIG. 20 is a flow diagram depicting an embodiment of a process for a processor in the robotic apparatus. At 2000, instruction is sent for an actuator position. For example, the processor sends instructions to the microcontrollers of the actuators to move tendons or parts such that the apparatus fingers move in a manner to sign the American Sign Language letter L. At 2002, the actuator position is validated. For example, the processor determines whether the apparatus fingers are in the “L” position. In various embodiments, the processor validates the actuator position via various mechanisms. For example, in various embodiments, the processor validates position by monitoring actuator current (e.g. to determine whether the actuator is drawing the amount of current expected for a given position), using embedded potentiometers (e.g. to determine a change in resistance), using angle sensors (e.g. by using a film that reports the angle it is bent at), using proximity sensors (e.g. to determine the spacing between joints), or using one or more cameras. At 2004, the processor determines whether the actuator is in the correct position. If the actuator is not in the correct position, at 2006 actuator movement is stopped and at 2008 an error is reported. For example, the machine may provide an error message to the user via a sound, vibration, a specific physical sign that indicates error, or otherwise. The error may be reported to a central server for servicing.

At this point it should be noted that the robotic apparatus in accordance with the present disclosure as described above may involve the processing of input data and the generation of output data to some extent. This input data processing and output data generation may be implemented in hardware or software. For example, specific electronic components may be employed in a robotic apparatus or similar or related circuitry for implementing the functions associated with actuating a robotic apparatus in accordance with the present disclosure as described above. Alternatively, one or more processors operating in accordance with instructions may implement the functions associated with actuating a robotic apparatus in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. An apparatus for providing controlled movement of a robotic appendage, comprising:
a digit, wherein the digit comprises a first joint and a second joint; and
an actuator configured to control a degree of freedom of the digit;
wherein the actuator causes the first joint to bend at a first rate from a first position to a second position and the second joint to bend at a second rate from a third position to a fourth position; and
wherein the first rate is faster than the second rate.

2. The apparatus of claim 1, wherein the actuator comprises a servo, motor, stepper, or linear actuator.

3. The apparatus of claim 1, wherein the digit comprises a wire, wherein the actuator is configured to control a degree of freedom of the digit by exerting a force on the wire.

4. The apparatus of claim 1, further comprising one or more return actuators, wherein the one or more return actuators are configured to return the first joint to the first position and return the second joint to the third position.

5. The apparatus of claim 1, further comprising an additional actuator configured to control an additional degree of freedom of the digit.

6. The apparatus of claim 5, wherein the additional actuator comprises an actuator configured to control flexion at a third joint of the digit.

7. The apparatus of claim 5, wherein the additional actuator comprises an actuator configured to control adduction and abduction of the digit.

8. The apparatus of claim 5, wherein the additional actuator is located at the point of motion and is configured to directly drive the digit.

9. The apparatus of claim 1, wherein the apparatus comprises a body, wherein the body comprises an arm, wherein the arm comprises the digit.

10. The apparatus of claim 9, wherein the arm comprises a shoulder joint, an elbow joint, and a wrist joint.

11. The apparatus of claim 1, wherein the apparatus comprises a user interface.

12. The apparatus of claim 1, wherein the apparatus comprises a camera.

13. The apparatus of claim 12, wherein the camera is capable of gesture recognition.

14. The apparatus of claim 1, wherein the apparatus comprises a physical feedback mechanism.

15. The apparatus of claim 14, wherein the physical feedback mechanism comprises a proximity sensor.

16. The apparatus of claim 1, wherein the actuator is controlled by a processor.

17. The apparatus of claim 16, wherein the processor is connected to a network.

18. The apparatus of claim 9, wherein the body comprises a head.

19. The apparatus of claim 18, wherein the apparatus is configured to change a position of the arm or digit to be in contact with the head.

20. A method for providing controlled movement of a robotic appendage, comprising:
receiving a command to control a degree of freedom of a digit, wherein the digit comprises a first joint and a second joint;
using an actuator to cause the first joint to bend at a first rate from a first position to a second position and the second joint to bend at a second rate from a third position to a fourth position,
wherein the first rate is faster than the second rate.
